(19) United States
(12) Patent Application Publication
(10) Pub. No.: US 2019/0122179 A1
(43) Pub. Date: Apr. 25, 2019

(54) SOFTWARE BASED REVENUE SHARING MODEL

(71) Applicant: Suhas Bonageri, Hubli (IN)

(72) Inventor: Suhas Bonageri, Hubli (IN)

(21) Appl. No.: 15/792,778

(22) Filed: Oct. 25, 2017

(51) Int. Cl. G06Q 10/10; G06Q 30/02; H04L 29/08

(52) U.S. Cl. CPC G06Q 10/1053; H04L 67/02; H04L 67/306; G06Q 30/0277

(57) ABSTRACT

The present invention provides a single web based platform system and method for creating and organizing credential information comprising a server, a memory module, a database, and a user interface that will increase the job posting visibility, user interaction and engagement along with a secure medium to generate and share revenue, and in particular to relates to a software based revenue sharing model. This web based platform enables a user to get a share of the revenue by means of sharing the jobs posted by another user. The platform makes it easier for the user to track, respond, update and generate revenue through the job posting over this platform. The disclosed invention makes it easier to spread the job feed quickly and increase the traction over the same and in turn making it beneficial for both the recruiter and the user.

### FIELD OF THE INVENTION

The present invention relates in general to method of generating and sharing revenues, and in particular to software based system and method for revenue sharing model pertaining to recruitment and employment sector. This method enables a user to get a share of the revenue by means of sharing the jobs posted by the user.

### BACKGROUND AND PRIOR ART

The present trend in the field of job seeking is to find, select, apply and even go through the total selection process entirely through an Internet based software application. There exist numerous prior arts that deals with recruitment and uses various methods to facilitate the same. One such prior art is US20090187473A1 wherein an online recruiting solution provides recruiters with comparative information for candidates that is germane to a particular activity and role.

Further U.S. Pat. No. 6,370,510B1 wherein a method and apparatus for providing an interactive computer-driven employment recruiting service. The method and apparatus enables an employer to advertise available positions on the Internet, directly receive resumes from prospective candidates, and efficiently organize and screen the received resumes. The method and apparatus further is capable of monitoring employment advertisements for a job seeker and automatically notifying the job seeker when a position for which the job seeker is suitable becomes available.

We see that in any recruitment activity, different players are involved. A job seeker browses the Internet for job postings, which are posted by either the recruiter or an agency, called the first user. The agency is authorized by the recruiter to do the job vacancy postings. A financial transaction takes place between the recruiter and his agent.

It has become clear that for the job postings to be seen by the maximum number of job seekers, the postings must be made available to the largest number of candidates. Here emerges the role of a second tier of users, each of whom is required to enlist a set of job seekers as ‘followers’. The recruiter's agency can then share the job postings with the said second tier users, who in turn may ensure a much greater exposure of the postings through their followers. It is again clear that some financial transaction must undergo between the first and the second users and the dedicated website/portal for this set-up to function successfully. A robust method for distribution of the monetary sums involved is therefore essential, in the absence of which such a network cannot function in the long run.

Unfortunately, the prior art gives no method for sharing of the revenue between the said parties involved in the above-mentioned activity.

The present invention seeks to provide a method for such revenue sharing and thereby overcome this drawback of the prior art.

### OBJECTS OF THE INVENTION

The present invention has been developed in response to the present state of the art, and in particular, in response to the problems and needs in the art that have not yet been fully solved by currently available techniques and processes.

Accordingly, the present invention has been developed to provide single web based platform system and method for creating and organizing credential information comprising a server, a memory module, a database, and a user interface that will increase the job posting visibility, user interaction and engagement along with a secure medium to generate and share revenue; in order to successfully overcoming all of the above-discussed shortcomings in the art.

The primary object of the present invention is to provide a method for sharing of revenue between different layers of users in the field of job seeking.

Another object of the present invention is to provide a method which raises the number of job seekers who are exposed to the job postings.

A further object of the present invention is to provide a method which enables revenue sharing with the second and downstream users.

Yet another object of the present invention is to provide a method which increases the foot print of the job postings.

How the foregoing objects are achieved will be clear from the following brief description. In this context, it is clarified that the description provided is non-limiting and is only by way of explanation. Other objects and advantages of the invention will become apparent as the foregoing description proceeds, taken together with the accompanying drawings and the appended claims.

### BRIEF DESCRIPTION OF THE ACCOMPANYING DRAWINGS

In order to describe the manner in which the above-recited and other advantages and features of the invention can be obtained, a more particular description of the invention briefly described above will be rendered by reference to specific embodiments thereof, which are illustrated in the appended drawings. And that the elements of similar structure or function are generally represented by reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 is an example of accessing the job posting on the web based platform hosted on the Cloud.

FIG. 2 is a flow diagram showing the interaction between the different players involved in the job posting and revenue sharing activity.

### DETAILED DESCRIPTION OF THE INVENTION

This invention disclosure describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. In the present description, persons have been described in the masculine gender for brevity. It may be clearly understood that the invention applies equally to persons of all genders.

The present invention discloses a common user web based platform allowing the multiple users present at various levels to interact and propagate the job postings available on the platform and thereby able to secure a variable amount of revenue associated with the job posting based on the parameters specified on the platform. The web based platform system and method for creating and organizing credential information and revenue distribution comprising a server, a memory module, a database, and a user interface that will increase the job posting visibility, user interaction and engagement along with a secure medium to generate and share revenue.

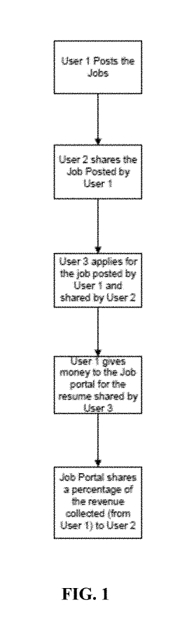

In one embodiment of the present invention provides a web based platform system of multiple users; these multiple users may be categorized in three levels wherein, User1 is a user who posts the jobs who may be a recruiter, HR agency or related people, at another level, User 2 is a user who follows User 1 and User 3 is a user who follows User 2 as illustrated in FIG. 1. There can be many users at all the levels except at first level for one job posting i.e. at User 1 level for a particular job posting. Each job posting cycle will be identified by the job posted and will relate to the single user 1 posting that job. There can be n number of User 1 for different different job posting on the portal, but each User 1 will be fixed for single Job posting.

For example, Alex posts a Job for the profile of Teacher, Alex have 10 User 2 and each of the User 2 that follows Alex also have some followers that may be specified as User 3. But Alex will be a fixed single User 1 in context to Job posting for the profile of Teacher.

Simultaneously, Peter posts a Job for the chef, peter have 10 User 2 and each of the User 2 that follows peter also have some followers that may be specified as User 3. But peter will be a fixed single User 1 in context to Job posting for the profile of Chef.

Therefore, there may exist multiple User 1 on the disclosed web based platform, who will have their line of followers to propagate the job postings, However, for each unique Job posting there will be a single User 1 related to Job posted. As discussed above, in the web based portal, both Alex and Peter who posted different job postings on the portal are designated as User 1 for each corresponding job posting at the same time on the portal, so there can be many User 1 for each and every different job posting cycle, which may be further propagated on the portal through User 2 and User 3, who may be different or common to both the User 1 fixed and identified for each unique Job posting.

There can be a scenario wherein the User 1 can be a User 1 for multiple different job posting he posted on the portal, For example, Alex may post multiple different job posting for the post of Teacher, Chef, Flight attendant etc. For each of this postings Alex will be a fixed User 1. It is pertinent to note that each of the User 1 and subsequent User 2 and User 3 may be interchangeable with respect to change in different Job postings. But for each of the single job posting one User 1 will be fixed, through which the Job posting Pathway is tracked i.e the pathway of job propagation and finally selected user profile. There may be an instance where a User 1 can be a User 2 or User 3 in this Job posting Trajectory depending upon its Action. For example, Alex and Peter both are User 1 for different unique job posting they made on the portal. Suppose, Alex is User 1 who posted for the requirement for a teacher and Peter posted for a requirement of Chef, both Alex and peter are User 1 for each of their job postings, but in case Peter applies or react to Alex job posting of a teacher, peter will become User 2 for the job posting placed by Alex for the post of teacher and vice-versa. It is pertinent to note that Chain and Job posting cycle and hierarchy of User 1, User 2 and User 3 is dependent on the Job posting and the designation of User 1, User 2 and User 3 is interchangeable depending on their action towards a Job posting. However, the cycle will have only one and fixed single User 1 for every different Job posting.

The software based revenue sharing model according to the present invention operates along with a dedicated web portal. In another aspect, a computer program for making the portal functional herein includes a computer program product embodied on a computer readable medium that, when executing on one or more computing devices, performs the steps of: Registration of users; validation of user profiles; Tracking of Job postings and profiles; Rating system; and Revenue distribution over a data network to users involved. The web based platform disclosed herein enables every user to feed the customary details such as name, address, email, contact number and other credentials and then upon validation of the profile the web based platform allots a unique identifier to each of the user profile made on the platform. This unique identifier helps in keep the track of the user profiles, responses to the job postings and also enables in facilitating the correct allotment of the payment from the user 1 and the referral user, which may be anyone from the pool of user 2 and user 3.

In one embodiment of the present invention, a web based platform system and method as disclosed herein rewards user affiliates in lieu of job posting visibility and conversions of leads. The system provides a platform to attract and reward generators of both Job posting users and Job applicants.

In one embodiment, the system provides a user interface or application programming interface (API) through which user posting jobs or recruiters can post their job postings into the network. Their followers or secondary user (User 2)or affiliates can repost or share the job posting to their network, manage their posting and profiles on user interface, and maximize the benefit they receive through propagating or sharing the job posting on their own user dashboard. In one embodiment, the user interface is in the form of a web page rendered in a web browser of a user device, such as a computer, a notebook, a PDA, a web terminal, etc. The web page is to be downloaded from a server that is connected to the database for the job postings. Alternatively, the user interface can be based on a wireless mobile device, such as a cellular phone. Further, similar entry fields can be provided through the use of other communication channels, such as Email, Instant messages, SMS messages, etc. The user interface contains entry fields for specifying the information and details about the users involved, in order to identify, locate, filter and manage each user profile.

In one embodiment, the system provides the users with tools to manage and track the performance of their followers or Users or Affiliates, both individually and as a whole. In return for supplying the relevant profiles to the job posting available on the network, the system rewards the users. In one embodiment, the supply of profile reward or revenue is based on the leads received, or the selection conducted through the network or other measurable benefits received, by the user of the job postings. This revenue or reward can be manifested in various forms including, but not limited to, percentile commissions, revenue share on lead charges or commerce transactions, bounties, lump sums, etc.

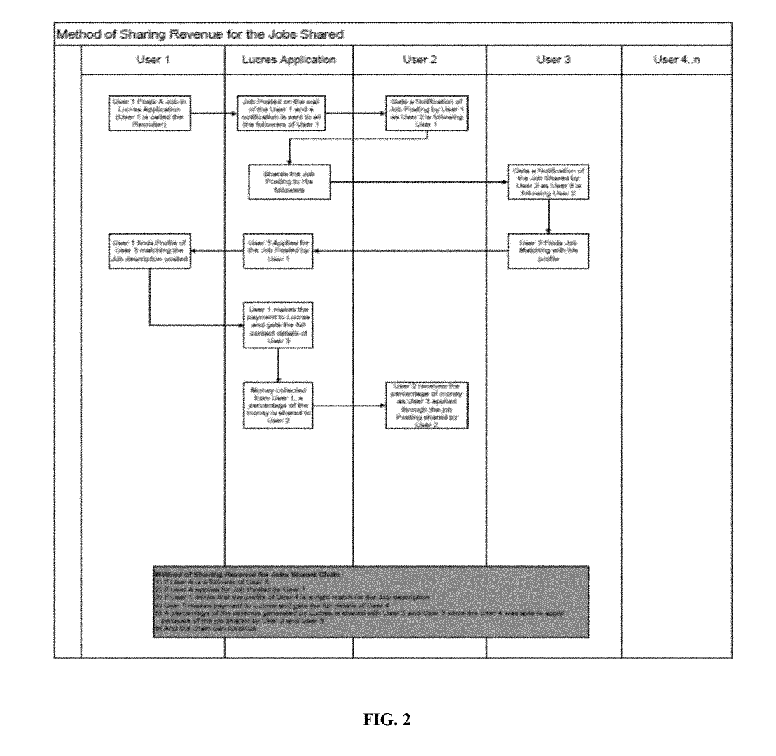

We refer to FIG. 2 depicts the interaction and revenue sharing process between the user (User 1) who post the jobs and the users (User 2) who follows User1 and User 3 who follows User 2.The process begins after the completion of registration by the users and validation of their profiles. Each of the users has its own login, profile and dashboard. The dashboard has numerous features which may range from search, management of profile details; a button system unique to the given invention, wherein the users interact and form their network on the platform with each other by using the button present with the profiles. Following the User is by means of buttoning him. This diagram therefore illustrates the software based revenue sharing model according to the present invention. The method is described hereunder with reference to FIG. 2.

When a User (User 2) wants to follow someone on the current invention web based platform or keep an update about any other user on the website, he must put a button on that particular person (User 1). The buttoned page is like any news feed page where a user gets all the details, posts or job posts or updates of all the people the user has put his buttons on. User1 posts a job on the web based platform. If the posting does not comply with the requirements stipulated by the website, the posting is not accepted and the website informs user1 accordingly.

When accepted by website, the job posting is shared with a plurality of User2 who are following the User1. Next, each User2 shares the job posting with his followers, who are termed as User3. And as explained in para [0011-0014], there may exist multiple User 1 for each of the different job posted on the portal. It is to be understood clearly that there may be several User 2 and each User2 may have several followers who have buttoned him, i.e. User3. User3 can see the job shared by User 2 since User 3 is following User 2 (by means of buttoning the user).There may be one or more User3 who finds the job shared by User 2 suitable for the job posted and applies for the job. Next, the User1 gets the resume of User3 without contact details like e-mail and phone number.

User 1 feels that the resume of User 3 suits the job description. Now User 1 makes the payments to web portal to get the contact details of User 3. Once the payment is made by User 1, then a percentage of the revenue earned by web portal for that particular job posting is shared with the users responsible for connecting to User 3.

Since User 2 has connected User 3 to the User 1, a part of the revenue, which is received by the web portal from the User1 for receiving User3's resume, is shared with User 2 by the website. When the job posted by User1 is shared by User2 and if the User 3 has buttoned 2 or more User2 and the job is shared by more than one User 2 then on the wall of User3 only the User2 who has shared the job first will only be listed on the wall of User3. So, the revenue will be shared to User 2 only upon, selection of resume of User 3 by User1 and receipt of the payment by User 1 to Web portal.

The referral source of the selected user is identified through the unique identifier. The selected user may be from plurality of user 3 following the user 2 or directly from the plurality of user 2. The referral source of the selected user is identified by tracking its pathway, the selected user may be a buttoned follower of user 1, or any of the buttoned followers of user 2 specified as user 3.

User 2 will earn a share of the revenue only when any of his followers or downstream followers applies for the job and his resume gets selected by User1 and User1 makes the payments to Web portal. If no resume is selected by User1 then User2 may not earn any revenue. In this way, the revenue-sharing financial mechanism that is built by this software raises the number of job seekers who are exposed to the job postings. Also,the method according to the present invention increases the foot print of the job postings.

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device. In various embodiments, hardwired circuitry may be used in combination with software instructions to implement the present invention. Thus, the techniques are not limited to any specific combination of hardware circuitry and software or to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor. Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It can also be easily seen that this software enables revenue generation by the second users, making the arrangement a stable one. Thus, it meets all the goals of this invention.

The present invention has been described briefly with reference to some drawings and a preferred embodiment purely for the sake of understanding and not by way of any limitation and the present invention includes all legitimate developments within the scope of what has been described herein before. Since other modifications and changes varied to fit particular operating requirements and environments are apparent to those skilled in the art, the invention is not considered limited to the example chosen for purposes of disclosure, and covers all changes and modifications which do not constitute departures from the true spirit and scope of this invention.

This written description uses examples to disclose the invention, including the best mode, and also to enable any person skilled in the art to practice the invention, including making and using any devices or systems and performing any incorporated methods. The above are merely exemplary and illustrative of the inventive concept by, one of ordinary skill in the art in the specific embodiments described to make various modifications or additions, or a similar alternative manner, without departing from the invention. The invention, as defined in this disclosure or beyond the scope of the claims, should belong to the scope of the present invention.

I claim:

1. A common user web based platform comprising a server, a memory module, a database, and a user interface; allowing the multiple users present at various levels namely user 1, plurality of user 2 and plurality of user 3; to interact and propagate the job postings on the platform and secure a variable amount payment associated with the job posting through tracking the selected user pathway;
Wherein there may be multiple number of User 1 for different job posting on the portal, but each User 1 will be fixed for single Job posting; User 2 is a user who follows User 1 and User 3 is a user who follows User 2 and the selected user is applicant finalized by User1 against the job posting posted by user 1 on the portal.

2. The common user web based platform as claimed in claim 1, wherein, user interface further comprise of a registration module enabling the Registration of users; validation of user profiles; Tracking of Job postings and profiles; Rating system, User dashboard.

3. The common user web based platform as claimed in claim 1, wherein user 1 may have plurality of user 2 followers buttoned to user 1 dashboard and user 2 may have plurality of user 3 followers buttoned to user 2 dashboard; User 2 and User 3 may both react or apply to the job posting posted by user 1 on its dashboard; each of the user 2 and User 3 may only react and apply to the job posting one time.

4. The common user web based platform as claimed in claim 1, wherein User 1 upon selection of appropriate application makes the payments to web based platform to get the contact details of selected user.

5. The common user web based platform as claimed in claim 1, wherein the referral source of the selected user is identified through the unique identifier. The selected user may be from plurality of user 3 following the user 2 or directly from the plurality of user 2.

6. The common user web based platform as claimed in claim 1, wherein the referral source of the selected user is identified by tracking its pathway, the selected user may be a buttoned follower of user 1, or any of the buttoned followers of user 2 specified as user 3;
Job posting pathway and hierarchy of User 1, User 2 and User 3 is dependent on the Job posting and the designation of User 1, User 2 and User 3 is interchangeable depending on their action towards a Job posting; the Job posting pathway will have only one and fixed single User 1 for every different Job posting.

7. The common user web based platform as claimed in claim 1, wherein a part of the payment, received by the web based portal from the User 1 for receiving selected user profile may be shared with User 2 in case selected user or user 3 is follower of user 2;
or a part of the payment, received by the web based portal from the User 1 is shared to selected User 2 directly; in case the selected profile is identified as one of the plurality of User 2 buttoned to User 1.
